(19) United States
(12) Patent Application Publication
(10) Pub. No.: US 2006/0250258 A1
(43) Pub. Date: Nov. 9, 2006

(54) Device for barricading a room

(76) Inventor: Dag Anhamm, Moers (DE)

Correspondence Address: FELDMAN GALE, P.A.;MIAMI CENTER, 19TH FLOOR, 201 S. BISCAYNE BLVD., MIAMI, FL, 33131-4332, US

(21) Appl. No.: 11/384,898

(22) Filed: Mar. 20, 2006

(30) Foreign Application Priority Data
Mar. 21, 2005 (DE) 10 2005 013 462.9

(51) Int. Cl. G08B 21/00

(52) U.S. Cl. 340/610

(57) ABSTRACT

In order to seal a room from a fluid, particularly, a liquid, and, preferably, water flowing into the room or out of the room, a barricading device has a flap that is swivelable from a first position about an axis into a second position. The flap is pivoted by an actuator. The flap is held in the first position by a locking device, whereby actuation of an unlocking device connected with the locking device releases the flap for pivoting into the second position.

### CROSS-REFERENCE TO RELATED APPLICATION

This application claims the priority, under 35 U.S.C. § 119, of German patent application No. 10 2005 013 462.9, filed Mar. 21, 2005; the prior application is herewith incorporated by reference in its entirety.

### BACKGROUND OF THE INVENTION

1. Field of the Invention

The present invention pertains to a device for barricading a room against a fluid, in particular, a liquid that flows into the room or out of the room.

It is known that doors of a room, in particular, a room of a plant, are sealed by flaps that, when a fluid, in particular, a liquid, that appears in the room, accumulates so that adjacent rooms or the surrounding of the room does not come into contact with such liquids. The liquids may be water or mixtures containing water, chemicals, or oils. In particular, such liquids or liquid mixtures appear when water for fire-fighting is pumped into the room by the fire department or by a sprinkler system.

A room is not only a building or a part of a building, such as, for example, underground parking garage, workshop, etc., but also areas confined by boundaries, such as walls that have an opening that, if necessary, must be sealed.

A device for barricading rooms is already known from EP 0 754 822 A1 to Anhamm. With the Anhamm mechanism, a room can be barricaded against a liquid entering the room or leaving the room. For such a purpose, a flap that can be swiveled about a substantially horizontal axis is provided. By an actuator, the flap can be folded upward from a recess provided in the bottom of the room in dependence on a liquid entering the recess. The flap is embodied as a floating body. Different devices can be used for actuating the flap. Anhamm discloses that the actuator has at least one weight that is substantially vertically movably connected through a gearing with the axis about which the flap is swiveled. The weight effects a torque about the rotary axis that is greater than a torque acting about the axis by the weight of the flap, when the flap has been deflected from its substantially horizontal position in the recess by the liquid entering into the recess.

Actuation can also take place by providing at least one tension spring that is connected with the axis through a gearing and that effects a torque about the rotary axis. This torque is greater than a torque acting about the axis by the weight of the flap, when the flap has been deflected from its substantially horizontal position in the recess by the liquid entering into the recess.

According to the solution of Anhamm, the device is mechanically actuated solely by the arriving liquid, in particular, water, without requiring additional energy, such as electricity, pneumatic or hydraulic, as an unlocking mechanism.

### SUMMARY OF THE INVENTION

It is accordingly an object of the invention to provide a device for barricading a room against a fluid that overcomes the hereinafore-mentioned disadvantages of the heretofore-known devices of this general type and that further improves upon prior art devices for barricading a room against a fluid flowing into the room or out of the room, in particular, a flap that swivels only when a fluid a present.

With the foregoing and other objects in view, there is provided, in accordance with the invention, a device for barricading a room against a fluid flowing into or out of the room, including a flap swiveling from a first position into a second position about an axis, a drive swiveling the flap about the axis, a locking device holding the flap in the first position, and a unlocking device connected to the locking device and releasing the flap to pivot into the second position. The fluid is, in particular, water.

With the objects of the invention in view, there is also provided a device for barricading a room against a fluid flowing into or out of the room, including a swiveling room-barricading flap having a swivel axis about which the flap swivels from a first position to a second position, a drive connected to the flap and selectively swiveling the flap about the axis between at least the first and second positions, a locking device holding the flap in the first position, and a unlocking device releasing the hold of the locking device on the flap to swivel the flap to the second position when the unlocking device is actuated.

With the objects of the invention in view, there is also provided a device for barricading a room against a fluid flowing into or out of the room, including a swiveling room-barricading flap having a swivel axis about which the flap swivels from a first position to a second position, a drive connected to the flap and selectively swiveling the flap about the axis between at least the first and second positions, a locking device operatively connected with the flap, a unlocking device operatively connected with the locking device; and the locking device having an actuated state in which the locking device holds the flap in the first position and an unactuated state in which the unlocking device releases the hold of the locking device on the flap to permit the flap to swivel to the second position.

The device for barricading a room against a fluid flowing into a room or out of the room, in particular, a liquid, preferably, water, has a flap that can be brought from a first position into a second position by swiveling about an axis. An actuator is provided with which the flap can be swiveled about the axis. The device according to the invention is characterized by providing a locking device, with which the flap is held in the first position. An unlocking device that releases the flap is connected with the locking device so that the flap can be swiveled into the second position.

With the proposal according to the invention, the flap reaches from a first position into a second position only if a fluid is present. Flaps for barricading a room are also used in public areas, for example, in underground parking garages. Up until the time of the present invention, there existed a danger where the room could be barricaded without a fluid being present by manual actuation—lifting—of the flap.

In accordance with another feature of the invention, such a problem is avoided by providing a locking device that is connected with the unlocking device.

In accordance with a further feature of the invention, the locking device has at least one locking element that interacts with at least one fastening element that is embodied in correspondence to the locking element.

In accordance with an added feature of the invention, the locking element and/or the fastening element are movable, in particular, swivelable, relative to one another.

In accordance with an additional feature of the invention, the fastening element or the locking element is embodied in a hook-shape. A hook-shaped fastening element can, for example, be attached at the bottom, whereby the hook-shaped fastening element is swivelably disposed. Partly with the hook-shaped portion of the fastening element, this fastening element grips a bolt, for example, that represents a locking element and that is connected with flap. In doing so, the flap is held in a first position. By swiveling the hook-shaped fastening element, the element is no longer engaged with the locking element. Thus, the flap can be swiveled from the first position into the second position.

In accordance with yet another feature of the invention, the fastening element or the locking element can be embodied in a bolt-shape. If the fastening element is embodied in a bolt-shaped manner, the locking element can be embodied in the shape of a recess in the flap into which recess the fastening element engages. By swiveling or straight-line movement, the fastening element can be removed from the reception of the flap so that the flap can be swiveled from a first position into the second position about an axis.

In accordance with yet a further feature of the invention, the locking device is connected with the flap. This embodiment, however, is not the only possible embodiment. There is also a possibility that the locking device can be connected with the actuator or drive.

In accordance with yet an added feature of the invention, the unlocking device has at least one unit with which the level of a liquid is registered. The level of the liquid can be registered in a safety-relevant area. It is not absolutely necessary that the unit for registering the level is provided directly on the flap. The advantage of this embodiment can be seen in that the flap is unlocked very early, i.e., when the liquid has not yet reached the flap.

In accordance with yet an additional feature of the invention, the level of the liquid can be determined by a unit that has at least one optically, electrically, magnetically, and/or acoustically operating element. For example, these can be capacitively or inductively operating sensors. There is also a possibility that an electric contact is closed when a certain liquid level has been reached.

In accordance with again another feature of the invention, the level of the liquid can also be registered by a mechanically operating unit. For such a purpose, the unlocking device has, for example, at least one floating body.

In accordance with again a further feature of the invention, the unlocking device has at least one actuating unit for actuating the locking device. The actuating unit can be a mechanical and/or electric and/or electromagnetic actuating unit. The actuating unit can, for example, have at least one coil that generates an electromagnetic field that is sufficient for directly or indirectly actuating the locking device.

In accordance with again an added feature of the invention, the actuating unit and the unit with which the level of a liquid is registered are connected with one another in a signal-technical manner. The signal-technical connection can take place with electric or optical lines. It is also possible that the signal-technical connection between the actuating unit and the unit with which the level of a liquid is registered take place in a wirelessly. The signal-technical connection can also be achieved in that the actuating unit, for example, and the unit with which a level of a liquid is registered, are connected with one another through a cable line.

In accordance with a concomitant feature of the invention, the unlocking device is connected with a control device. The unlocking device is actuated by the control device when a suitable signal that is fed to the control device is present. The suitable signal can also be a signal that is independent on the presence of a fluid, in particular, a liquid. The device according to the invention is particularly suitable for barricading, for example, the entry to underground parking garage. To ensure that the barricading process is not triggered when, for example, a vehicle is in the process of passing a drive-through, the control device can have a corresponding registering device. An optical registering device, in particular, a camera system, is thereby preferred. If the registering device determines that, according to guidelines determined in the control device, a triggering of the barricading process is not to take place, the process does not take place until clearance is given. Preferably, the control device has at least one optic and/or acoustic signal device. The optic signal device can, for example, be a traffic light. With such a traffic light, a signal is generated that indicates entry into the underground parking garage, for example, is not permitted because the barricading process is being triggered or will soon be triggered.

Other features that are considered as characteristic for the invention are set forth in the appended claims.

Although the invention is illustrated and described herein as embodied in a device for barricading a room against a fluid, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a device according to the invention;

FIG. 2 is a fragmentary, enlarged perspective view of a first exemplary embodiment of the device according to the invention in an arrested state;

FIG. 3 is a fragmentary, enlarged perspective view of the device of FIG. 2 in a partly unlocked state; and

FIG. 4 a fragmentary, enlarged perspective view of a second exemplary embodiment of a device according to the invention.

### DESCRIPTION OF THE PREFERRED EMBODIMENTS

Referring now to the figures of the drawings in detail and first, particularly to FIG. 1 thereof, there is shown a block circuit diagram of a device according to the present invention for barricading a room against a fluid, particularly, a liquid, preferably, water, flowing into the room or out of the room. The device has a flap 1 that can be swiveled about an axis 2. In the illustrated exemplary embodiment, the flap 1 can be swiveled about a substantially horizontal axis. This configuration is not the only possible configuration. Also possible is a configuration where the flap 1 can be swiveled about a substantially vertical axis, for example.

The flap 1 can be swiveled from a first position into a second position. Preferably, the flap 1 is manufactured in a sandwich construction method in which the core of the flap is equipped with an extremely light and pressure-resistant material that allows for a high load capacity of the flap. Preferably, the flap is embodied such that vehicles, for example, can also drive over the flap 1. Preferably, the flap 1 is disposed in a non-illustrated box-shaped trough, whereby the surface of the flap 1 is flush with the top side of the trough, when the flap is in the second position. Generally, the trough is disposed in front of a door. Preferably, the flap 1 is dimensioned such that, in the second position of the flap 1, the flap 1 extends at least across the entire width of the door so that a liquid cannot flow through the doorway into an adjacent room or into the surroundings of the room.

As schematically illustrated in FIG. 1, an actuator 3 that carries out a swiveling of the flap 1 from the first position into the second position is connected with the flap 1.

The actuator 3 can, for example, be the type of actuator described in Anhamm.

Reference numeral 4 characterizes a locking device with which the flap 1 is held in the first position. An unlocking device 5 is provided that cooperates with the locking device 4 so that the flap 1 is released for swiveling into the second position. The unlocking device 5 has a unit 6 with which a level of a liquid is registered. The unit 6 can be disposed adjacent to the flap 1. This is not a required configuration. The unit 6 can also be disposed in a location where a liquid will most likely be present before it reaches the flap 1.

A control device 19 is connected with the unlocking device 5. The control device 19 supplies a suitable signal to the unlocking device 5 so that the unlocking device 5 can or cannot be actuated.

The control device 19 is equipped with a recorder 20. The recorder 20 can be an optic or optical recorder, in particular, a camera system. Furthermore, the control device 19 is connected with an optic and/or acoustic signal device 21. With such an embodiment, the device of the present invention is particularly suitable to barricade the entry of an underground parking garage, for example. The recorder 20, for example, monitors the entry into an underground parking garage. If it is determined that, for example, a vehicle is passing a drive-through, the barricading process is not triggered, or it is delayed. If, however, the recorder 20 determines that, for example, no vehicle or the like is present in the drive-through, the barricading process can be triggered. A corresponding signal is also output to the optic signal device 21 so that a signal is generated to prohibit entry into the underground parking garage because the barricading process is being or will soon be triggered.

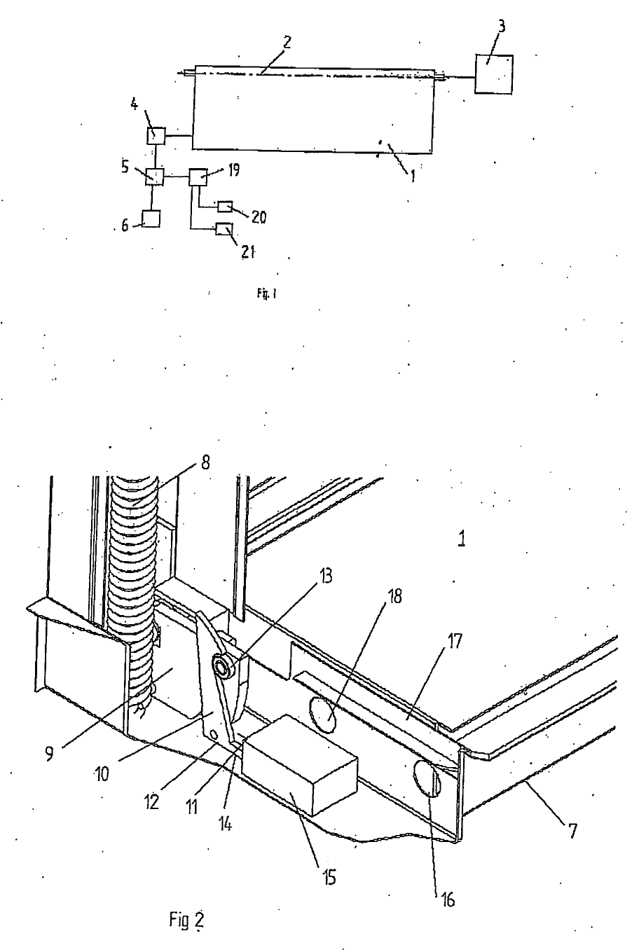

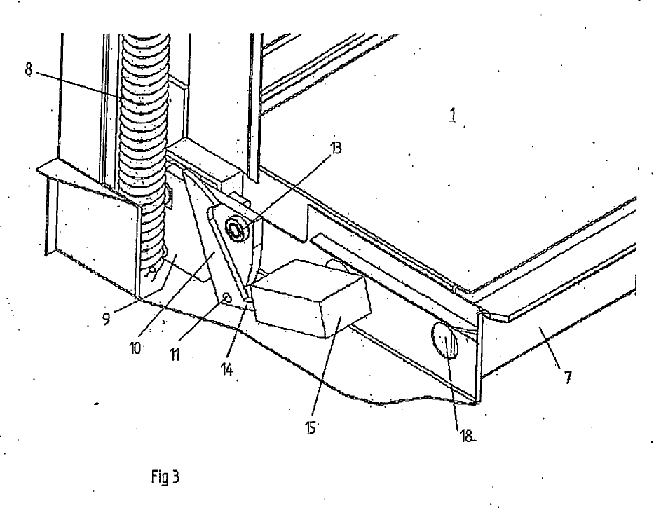

FIG. 2 shows, schematically, a second exemplary embodiment of a device for barricading a room against a fluid, particularly a liquid, preferably, water flowing into the room or out of the room. The device has a flap 1 that is disposed in a trough 7. An actuator 3 is connected with the flap 1. The actuator 3 is partly formed by tension springs 8 that are connected with a lever 9. The lever 9 is rigidly connected with the flap 1. In the illustrated position of the flap 1, the tension springs 8 are pre-stressed and exercise a substantially vertically upward traction force onto the lever 9. The lever 9 generates a torque about a non-illustrated axis 2 of the flap 1 so that the flap 1 can be swiveled from the first position into the second position.

The flap 1 is held in the first position illustrated in FIG. 2 by a locking device 4. The locking device has a hook-shaped locking element 10. The locking element 10 is connected at the bottom of the trough 7 through a fastener 11. The fastener 11 has a joint bolt 12 so that the locking element 10 can be swiveled about the joint bolt 12.

A fastening element 13 that corresponds to the hook-shaped locking element 10 is provided at the front end region of the lever 9. In the illustrated exemplary embodiment, the fastening element 13 is embodied in the shape of a bolt. The hook-shaped locking element 10 partly encompasses the fastening element 13.

An arm 14 in which a floating body 15 is attached is connected with the locking element 10.

The floating body 15 and the lever 14 are embodied so that the locking element 10 is swiveled around the joint bolt 12 when a critical level of the liquid in the trough 7 is reached so that the locking element 10 releases the fastening element 13.

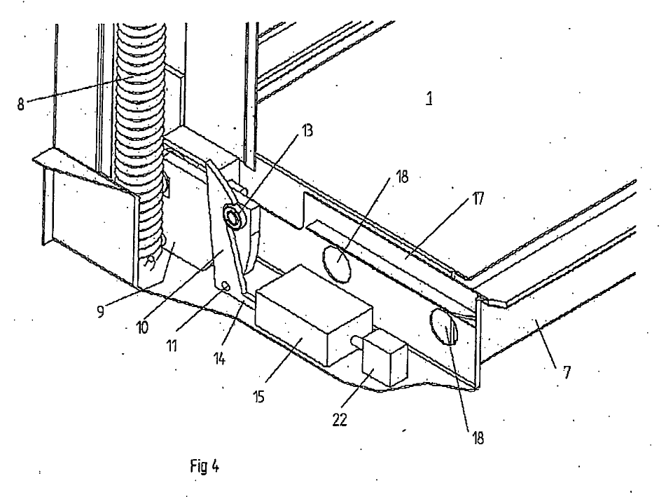

FIG. 3 illustrates a position of the locking element 10 in which the fastening element 13 is released.

The lever arm 14 and the floating body 15 can, thereby, be embodied such that the fastening element 13 is released by the locking element 10 before the flap 1 is afloat in the trough 7. Preferably, the floating body 15 is disposed in a chamber 16 of the trough 7, whereby the chamber 16 is separated from the remaining trough by a dividing wall 17, whereby overflow openings 18 are present in the dividing wall 17. Such a configuration creates the possibility of the chamber 16 initially filling with a liquid to achieve an unlocking process.

FIG. 4 illustrates a second exemplary embodiment of the device according to the invention. The basic concept of the second exemplary embodiment substantially corresponds to the exemplary embodiment of the device according to the invention as illustrated in FIGS. 2 and 3. The same parts have been provided with the same reference numerals.

A floating body 15 is provided in FIG. 4. In its starting position, the floating body 15 is held down by a unit 22. The unit 22 prevents the floating of the floating body 15 to the surface and the unlocking process is, thus, prevented. The unit 22 of the unlocking device 5 only releases the floating body 15 when a corresponding signal has been transmitted to the unlocking device 5 from a control device 19 (shown only diagrammatically in FIG. 1). The unit 22 can, for example, be a magnetic lock. It is also possible for the unit 22 to be a mechanically or electrically operating unit.

I claim:

1. A device for barricading a room against a fluid flowing into or out of the room, comprising:
a flap swiveling from a first position into a second position about an axis;
a drive swiveling said flap about said axis;
a locking device holding said flap in said first position; and
a unlocking device connected to said locking device and releasing said flap to pivot into said second position.

2. The device according to claim 1, wherein:
said locking device has at least one locking element; and
at least one fastening element operatively engages said locking device and is shaped to correspond to a shape of said locking element.

3. The device according to claim 2, wherein at least one of said locking element and said fastening element move relative to one another.

4. The device according to claim 3, wherein at least one of said locking element and said fastening element swivel relative to one another.

5. The device according to claim 2, wherein one of said fastening element and said locking element are hook-shaped.

6. The device according to claim 2, wherein one of said fastening element and said locking element are bolt-shaped.

7. The device according to claim 1, wherein said locking device is connected with said drive.

8. The device according to claim 1, wherein said locking device is connected with said flap.

9. The device according to claim 1, wherein said unlocking device has at least one liquid level registration unit for registering a level of a liquid.

10. The device according to claim 9, wherein that said liquid level registration unit has at least one element selected from the group consisting of an optical operating element, an electrical operating element, a magnetic operating element, and an acoustically operating element.

11. The device according to claim 9, wherein said unlocking device has at least one floating body.

12. The device according to claim 1, wherein said unlocking device has at least one actuating unit for actuating said locking device.

13. The device according to claim 12, wherein said actuating unit and said liquid level registration unit are connected with one another in a signal-technical manner.

14. The device according to claim 12, wherein said actuating unit and said liquid level registration unit are connected through a communication signal path.

15. The device according to claim 1, further comprising a control device connected to said unlocking device.

16. The device according to claim 15, wherein said control unit has at least one recorder.

17. The device according to claim 16, wherein said recorder is an optical recorder.

18. The device according to claim 17, wherein said optical recorder is a camera system.

19. The device according to claim 15, wherein said control device has at least one of an optical signaling device and an acoustic signaling device.

20. The device according to claim 1, wherein the fluid is water.

21. A device for barricading a room against a fluid flowing into or out of the room, comprising:
a swiveling room-barricading flap having a swivel axis about which said flap swivels from a first position to a second position;
a drive connected to said flap and selectively swiveling said flap about said axis between at least said first and second positions;
a locking device holding said flap in said first position; and
a unlocking device releasing the hold of said locking device on said flap to swivel said flap to said second position when said unlocking device is actuated.

22. A device for barricading a room against a fluid flowing into or out of the room, comprising:
a swiveling room-barricading flap having a swivel axis about which said flap swivels from a first position to a second position;
a drive connected to said flap and selectively swiveling said flap about said axis between at least said first and second positions;
a locking device operatively connected with said flap;
a unlocking device operatively connected with said locking device; and
said locking device having:
an actuated state in which said locking device holds said flap in said first position; and
an unactuated state in which said unlocking device releases the hold of said locking device on said flap to permit said flap to swivel to said second position.
